(19) United States
(12) Patent Application Publication
(10) Pub. No.: US 2016/0290248 A1
(43) Pub. Date: Oct. 6, 2016

(54) FUEL SUPPLY SYSTEM FOR INTERNAL COMBUSTION ENGINE AND CONTROL METHOD THEREFOR

(71) Applicants: AISAN KOGYO KABUSHIKI KAISHA, Obu-shi, Aichi (JP); TOYOTA JIDOSHA KABUSHIKI KAISHA, Toyota-shi, Aichi (JP)

(72) Inventors: Masakazu SUGISHITA, Tokai-shi (JP); Kenji HASHIMOTO, Nagoya-shi (JP)

(73) Assignees: AISAN KOGYO KABUSHIKI KAISHA, Obu-shi, Aichi-ken (JP); TOYOTA JIDOSHA KABUSHIKI KAISHA, Toyota-shi, Aichi-ken (JP)

(21) Appl. No.: 15/036,255

(22) PCT Filed: Nov. 25, 2014
(86) PCT No.: PCT/JP2014/081084

§ 371 Date: May 12, 2016

(30) Foreign Application Priority Data
Nov. 28, 2013 (JP) 2013-246592

(51) Int. Cl. F02D 19/06; F02D 41/14; F02D 41/24; F02D 41/00

(52) U.S. Cl. CPC F02D 19/0615; F02D 41/0027; F02D 41/1454; F02D 41/2438; F02D 41/2454; F02D 19/0647

(57) ABSTRACT

A fuel supply apparatus is constructed such that an engine fuel to be supplied by injection to an internal combustion engine can be selectively switched to a first fuel or a second fuel. The fuel supply apparatus is equipped with a control unit that performs air-fuel ratio learning related to the injection amount of the engine fuel such that the actual air-fuel ratio detected by an air-fuel ratio sensor installed in the internal combustion engine agrees with a target air-fuel ratio. During the operation with the first fuel, the control device permits the switching of the engine fuel from the first fuel to the second fuel after a condition that includes the completion of the air-fuel ratio learning related to the first fuel is met.

### TECHNICAL FIELD

The present invention relates to a fuel supply apparatus for an internal combustion engine and a method for controlling the apparatus that are configured to selectively switch engine fuel injected into an internal combustion engine between two engine fuels.

### BACKGROUND ART

Fuel supply apparatuses have been known that are configured to switch engine fuel injected into an internal combustion engine to one of a first fuel and a second fuel. For example, Patent Document 1 discloses an apparatus that selects, as engine fuel, one of gasoline and compressed natural gas (CNG) and switches the fuel supply systems to perform engine operation with different types of engine fuel.

As is known in the art, such an internal combustion engine needs to adequately burn air-fuel mixture. Therefore, air-fuel ratio learning is executed, in which a correction amount of the injection amount of engine fuel is learned such that the actual air-fuel ratio detected by an air-fuel ratio sensor agrees with a target air-fuel ratio. Since learned values, which are obtained through the air-fuel ratio learning, vary depending on the type of fuel used, the apparatus of Patent Document 1 executes air-fuel ratio learning for each of gasoline and CNG.

### PRIOR ART

### Patent Document

Patent Document 1: Japanese Laid-Open Patent Publication No. 2013-130157

### SUMMARY OF THE INVENTION

### Problems that the Invention is to Solve

It takes a certain amount of time for the above-described air-fuel ratio learning to be completed. Thus, in some cases, the engine fuel injected into the internal combustion engine is switched from a first fuel (for example, gasoline) to a second fuel (for example, CNG) before the air-fuel ratio learning related to the first fuel is completed. In this case, the air-fuel ratio cannot be properly controlled when the supplied fuel is switched from the second fuel to the first fuel. This destabilizes the combustion of the air-fuel mixture, which may cause disturbance in the air-fuel ratio.

Accordingly, it is an objective of the present invention to provide a fuel supply apparatus for an internal combustion engine and a method for controlling the apparatus that restrain disturbance in combustion of air-fuel mixture when the engine fuel injected into the internal combustion engine is switched to another engine fuel.

### Means for Solving the Problems

To achieve the foregoing objective and in accordance with one aspect of the present invention, a fuel supply apparatus is provided that is configured to switch an engine fuel injected into an internal combustion engine to one of a first fuel and a second fuel. The apparatus includes a control unit that executes air-fuel ratio learning related to an injection amount of the engine fuel such that an actual air-fuel ratio detected by an air-fuel ratio sensor provided in the internal combustion engine agrees with a target air-fuel ratio. During an operation with the first fuel, the control unit permits switching of the engine fuel from the first fuel to the second fuel after a condition is met that includes completion of the air-fuel ratio learning related to the first fuel.

To achieve the foregoing objective and in accordance with another aspect of the present invention, a method for controlling a fuel supply apparatus is provided. The apparatus is configured to switch an engine fuel injected into an internal combustion engine to one of a first fuel and a second fuel. The method includes: executing air-fuel ratio learning related to an injection amount of the engine fuel such that an actual air-fuel ratio detected by an air-fuel ratio sensor provided in the internal combustion engine agrees with a target air-fuel ratio; and during an operation with the first fuel, permitting switching of the engine fuel from the first fuel to the second fuel after a condition is met that includes completion of the air-fuel ratio learning related to the first fuel.

### BRIEF DESCRIPTION OF THE DRAWINGS

FIG. 1 is a diagram schematically showing an internal combustion engine that employs a fuel supply apparatus according to one embodiment.

FIG. 2 is a timing diagram showing transition of the operation modes of the fuel system of the fuel supply apparatus shown in FIG. 1.

FIG. 3 is a flowchart showing the procedure of a process for determining whether a first transition condition is met in the fuel supply apparatus shown in FIG. 1.

### MODES FOR CARRYING OUT THE INVENTION

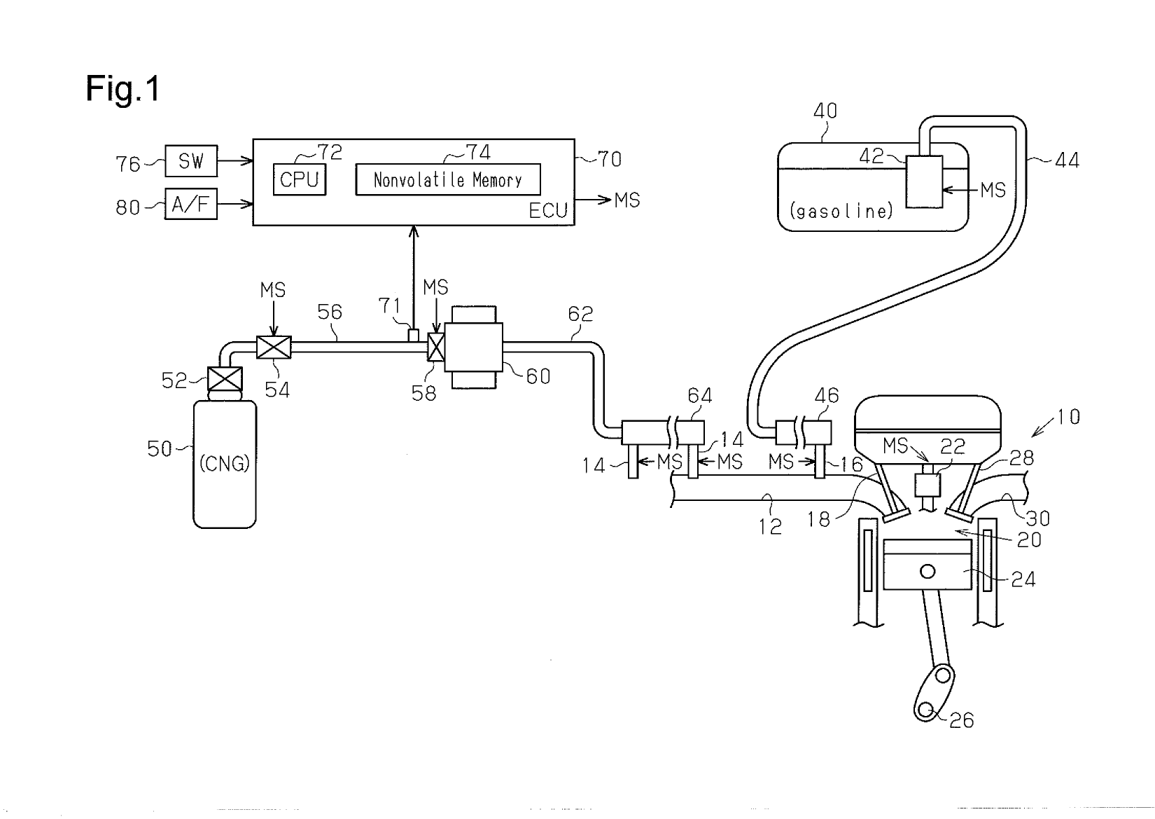

A fuel supply apparatus according to one embodiment will now be described with reference to FIGS. 1 to 3.

An internal combustion engine 10 shown in FIG. 1 selects and uses, as the engine fuel, one of a first fuel, which is gasoline, and a second fuel, which is compressed natural gas (CNG). Although the internal combustion engine 10 has multiple cylinders in the present embodiment, only one of the cylinders is shown in FIG. 1.

An intake passage 12 is connected to each cylinder. A CNG injector 14 and a gasoline injector 16 are provided in the intake passage 12. In the intake passage 12, air-fuel mixture is generated from intake air and fuel injected into the intake passage 12 by the CNG injector 14 or the gasoline injector 16. The air-fuel mixture is drawn into a combustion chamber 20 as an intake valve 18 is opened and burned in the combustion chamber 20 by an ignition plug 22. The generated combustion energy is converted into rotational energy of a crankshaft 26, which is mechanically coupled to the drive wheels of the vehicle (not shown). Thereafter, as an exhaust valve 28 is opened, exhaust gas, which is generated by combustion of the air-fuel mixture, is discharged to a discharge passage 30.

Next, the fuel supply apparatus, which supplies fuel to the combustion chambers 20 of the internal combustion engine 10, will be described.

CNG to be supplied to the CNG injectors 14 is stored in a CNG cylinder 50. The CNG in the CNG cylinder 50 is supplied to a CNG delivery pipe 64 via a high-pressure-side passage 56 and a low-pressure-side passage 62. The CNG in the CNG delivery pipe 64 is injected into each intake passage 12 through one of the CNG injectors 14, which are allocated to the respective cylinders. A manual valve 52 and an electromagnetically driven first shutoff valve 54 are provided between the CNG cylinder 50 and the high-pressure-side passage 56.

An electromagnetically driven second shutoff valve 58 and a regulator 60 are provided between the high-pressure-side passage 56 and the low-pressure-side passage 62. The regulator 60 lowers the pressure of CNG supplied from the CNG cylinder 50 to a predetermined pressure. The CNG, the pressure of which has been lowered to the predetermined pressure, is supplied to the CNG delivery pipe 64 via the low-pressure-side passage 62.

A pressure sensor 71 is provided in the high-pressure-side passage 56. The pressure sensor 71 detects, as a high-pressure detection value PH, the pressure in a section of the high-pressure-side passage 56 that is upstream of the second shutoff valve 58.

On the other hand, gasoline to be supplied to the gasoline injectors 16 is stored in a gasoline tank 40. The gasoline in the gasoline tank 40 is drawn by a fuel pump 42 and is supplied to a gasoline delivery pipe 46 via a gasoline supply passage 44. The gasoline in the gasoline delivery pipe 46 is injected into each intake passage 12 through one of the gasoline injectors 16, which are allocated to the respective cylinders.

An electronic control unit (ECU) 70 includes a central processing unit (CPU) 72 and a nonvolatile memory 74. The CPU 72 executes various programs stored in the nonvolatile memory 74. The nonvolatile memory 74 is a memory device, which stores various programs and data.

The ECU 70 executes a control process for burning air-fuel mixture in the combustion chambers 20 by delivering an operation signal MS to various types of actuators such as the first shutoff valve 54, the second shutoff valve 58, the CNG injector 14, the gasoline injectors 16, the ignition plugs 22, and the fuel pump 42.

The ECU 70 is also connected to a selector switch 76, which is operated by a user when selecting CNG as the engine fuel. The ECU 70 performs engine operation with one of CNG and gasoline in accordance with manipulation of the selector switch 76.

When performing engine operation using the CNG injectors 14, the ECU 70 controls the first shutoff valve 54 and the second shutoff valve 58 to be open, so that the CNG injectors 14 and the CNG cylinder 50 are connected to each other. Then, the ECU 70 selectively opens and closes each CNG injector 14 so that the CNG injector 14 injects CNG into the corresponding intake passage 12. Hereinafter, a fuel system operation mode for performing engine operation with CNG will be referred to as a CNG operation mode.

In contrast, when performing engine operation using the gasoline injectors 16, the ECU 70 drives the fuel pump 42 to supply gasoline from the gasoline tank 40 to the gasoline injectors 16. Then, the ECU 70 selectively opens and closes each gasoline injector 16 so that the gasoline injector 16 injects gasoline into the corresponding intake passage 12. Hereinafter, a fuel system operation mode for performing the engine operation with gasoline will be referred to as a gasoline operation mode.

When the engine operation using the CNG injectors 14 is not performed, the first shutoff valve 54 and the second shutoff valve 58 are controlled to be closed, so that the CNG injectors 14 and the CNG cylinder 50 are disconnected from each other.

The internal combustion engine 10 has an air-fuel ratio sensor 80, which is a known sensor and is arranged in at least one of the discharge passages 30. The air-fuel ratio sensor 80 is connected to the ECU 70. The air-fuel ratio sensor 80 delivers a signal that corresponds to the actual air-fuel ratio to the ECU 70.

The ECU 70 executes air-fuel ratio learning to allow air-fuel mixture to be properly burned in a stable state in the internal combustion engine 10. The air-fuel ratio learning is a known learning process, in which a correction amount for correcting the injection amount of the engine fuel is learned such that the actual air-fuel ratio detected by the at least one air-fuel ratio sensor 80 agrees with a target air-fuel ratio, which is set based on the engine operation state. For example, when the actual air-fuel ratio is richer than the target air-fuel ratio, the correction amount is learned so that the fuel injection amount is reduced. In contrast, when the actual air-fuel ratio is leaner than the target air-fuel ratio, the correction amount is learned so that the fuel injection amount is increased. Since the learned value (correction amount), which is obtained through the air-fuel ratio learning, varies depending on the type of fuel used, the air-fuel ratio learning is executed for each of gasoline and CNG in the present embodiment.

Next, transition of the operation mode of the fuel system will be described. Specifically, the transition from the gasoline operation mode to the CNG operation mode performed by the ECU 70 will be discussed.

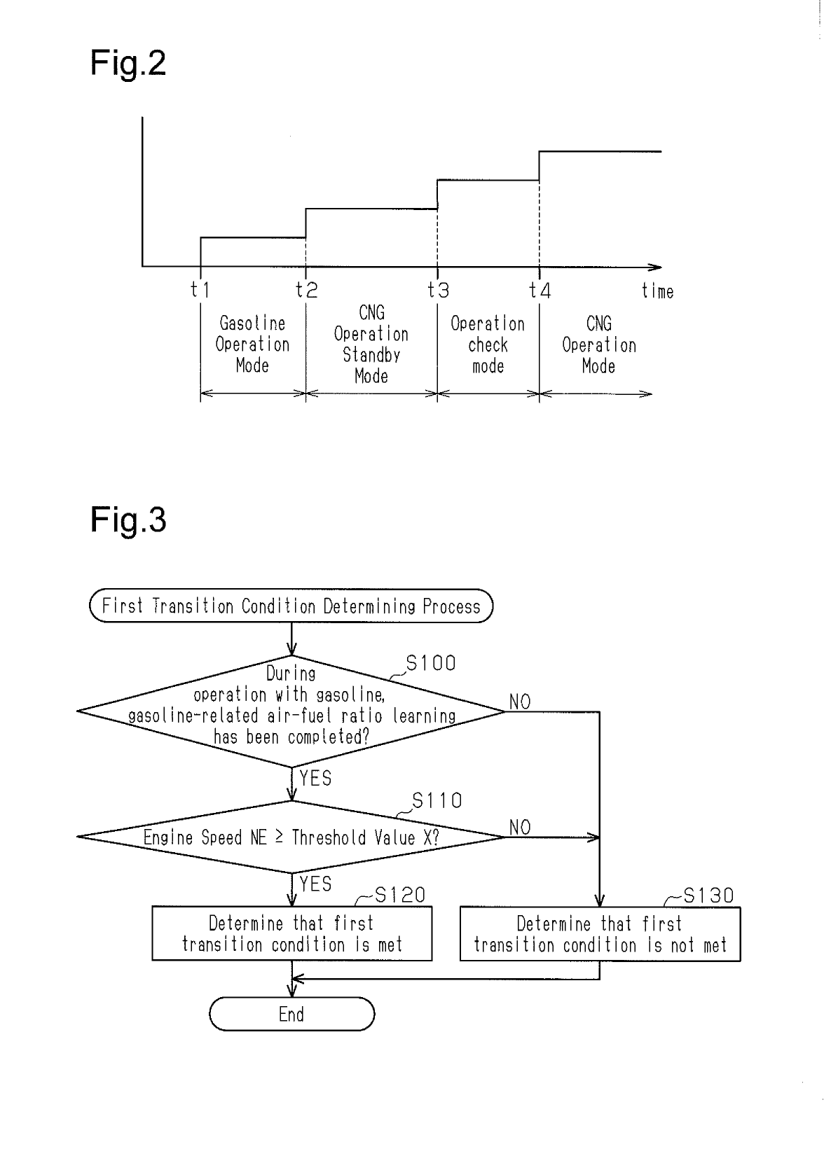

FIG. 2 shows transition of the operation mode of the fuel system when switched from the gasoline operation mode to the CNG operation mode.

First, when the ignition switch is switched to the ON position, and the engine starting operation is initiated (point in time t1), the ECU 70 sets the fuel system operation mode to the gasoline operation mode. Accordingly, during the engine starting operation, the engine 10 is operated with gasoline. In the engine operation with gasoline, the engine power is higher than in the engine operation with CNG. Thus, gasoline is forcibly selected as the engine fuel during the engine starting operation, in which combustion tends to be unstable.

During the execution of the gasoline operation mode, if the user requests the engine operation with CNG, that is, if the user switches the selector switch 76 to the ON position (point in time t2), the ECU 70 sets the fuel system operation mode to a CNG operation standby mode. The CNG operation standby mode is a transition mode at a first step.

In the CNG operation standby mode, the engine operation with gasoline is continued. The ECU 70 determines whether a first transition condition is met. The first transition condition is one of the conditions for permitting the operation mode to be switched to the CNG operation mode.

FIG. 3 shows a procedure of a process for determining whether the first transition condition is met.

When the process is started, the ECU 70 determines whether gasoline-related air-fuel ratio learning has been completed during the operation with gasoline (S100).

If it is determined that the gasoline-related air-fuel ratio learning has been completed (S100: YES), the ECU 70 determines whether the engine speed NE is greater than or equal to a threshold value X (S110). As the threshold value X, a value is used that is higher than the idle speed of the internal combustion engine 10 and the lowest value of the engine speed that stabilizes combustion of air-fuel mixture even during the engine operation with CNG.

When it is determined that the engine speed NE is greater than or equal to the threshold value X (S110: YES), the ECU 70 determines that the first transition condition is met (S120), and ends the process.

In contrast, when it is determined that the gasoline-related air-fuel ratio learning has not been completed at step S100 (S100: NO) or when it is determined that the engine speed NE is lower than the threshold value X at step S110 (S110: YES), the ECU 70 determines that the first transition condition is not met (S130), and ends the process.

When it is determined that the first transition condition is not met (S130) through the first transition condition determining process, the CNG operation standby mode is continued.

On the other hand, when it is determined that the first transition condition is met (S120), the fuel system operation mode is switched from the CNG operation standby mode to an operation check mode (point in time t3 in FIG. 2). The operation check mode is a transition mode at a second step.

In the operation check mode, the first shutoff valve 54 and the second shutoff valve 58 are controlled to be open while the engine operation with gasoline is continued. Then, whether each CNG injector 14 operates normally is checked. Whether the CNG injector 14 operates normally can be checked in any suitable manner. For example, the operation of each CNG injector 14 can be checked based on changes in the pressure in the CNG delivery pipe 64 and/or based on fluctuation of the engine speed NE when the CNG injector 14 is selectively opened and closed.

When it is determined that the CNG injectors 14 are operating normally in the operation check mode, it is determined that a second transition condition for proceeding to the CNG operation mode is met, and the fuel system operation mode is switched from the operation check mode to the CNG operation mode (point in time t4 in FIG. 2).

In contrast, if it is determined that any of the CNG injectors 14 is not operating normally in the operation check mode, switching to the CNG operation mode is prohibited.

The present embodiment as described above achieves the following advantage.

(1) In the first transition condition determining process shown in FIG. 3, the first transition condition is determined to be met (S120) when it is determined that the gasoline-related air-fuel ratio learning has been completed at least during the operation with gasoline (S100: YES). If the first transition condition is met, the engine operation is switched from the operation with gasoline to the operation with CNG. When the gasoline operation mode is switched to the CNG operation mode, switching of the engine fuel from gasoline to CNG is permitted after the gasoline-related air-fuel ratio learning is confirmed to be completed.

Thus, when the engine fuel is switched back to gasoline after being switched from gasoline to CNG, the gasoline-related air-fuel ratio learning has already been completed. Therefore, when the engine fuel is switched back from CNG to gasoline, the air-fuel ratio control can be readily started in an adequate state. Accordingly, when the engine fuel is switched back from CNG to gasoline, the combustion of air-fuel mixture is restrained from being unstable.

(2) In some cases, switching of the engine fuel from gasoline to CNG is permitted after the gasoline-related air-fuel ratio learning is completed during the operation with gasoline. In such a case, if the state continues in which the gasoline-related air-fuel ratio learning is not completed, switching of the engine fuel from gasoline to CNG is not permitted unless the gasoline-related air-fuel ratio learning is completed.

In the present embodiment, gasoline is used as the engine starting fuel, which is used for starting the engine 10. That is, since fuel that is first used when starting the engine operation is gasoline, the gasoline-related air-fuel ratio learning can be completed prior to the CNG-related air-fuel ratio learning. Therefore, switching of the engine fuel from gasoline to CNG is reliably permitted. On the next and subsequent engine starting operations, the gasoline-related air-fuel ratio learning will have already been completed. Thus, for example, the engine starting performance is restrained from deteriorating due to a difference between the actual air-fuel ratio and the target air-fuel ratio at the engine starting operation.

The above embodiment may be modified as follows.

The first transition condition includes “the completion of the gasoline-related air-fuel ratio learning during the operation with gasoline” and “the engine speed NE being greater than or equal to the threshold value X.” However, advantage (1) can be achieved if at least “the completion of the gasoline-related air-fuel ratio learning during the operation with gasoline” is set as the first transition condition.

“The engine speed NE being greater than or equal to the threshold value X” as the first transition condition may be replaced by another condition as necessary.

“The completion of the gasoline-related air-fuel ratio learning during the operation with gasoline” does not need to be included in the first transition condition, but may be included in the second transition condition.

If it is confirmed in advance that the CNG injectors 14 operate normally, the second transition condition may be omitted, so that the fuel system operation mode is directly switched from the CNG operation standby mode to the CNG operation mode.

In the above illustrated embodiment, the engine starting fuel is gasoline. However, the engine starting fuel may be CNG.

In the illustrated embodiment, the first fuel injected into the internal combustion engine 10 is gasoline, and the second fuel is CNG. However, these fuels may be other fuels. Engine fuels other than those above include light oil, alcohol, liquid natural gas (LNG), hydrogen gas, and diethyl ether.

1. A fuel supply apparatus that is configured to switch an engine fuel injected into an internal combustion engine to one of a first fuel and a second fuel, comprising
a control unit that executes air-fuel ratio learning related to an injection amount of the engine fuel such that an actual air-fuel ratio detected by an air-fuel ratio sensor provided in the internal combustion engine agrees with a target air-fuel ratio,
wherein, during an operation with the first fuel, the control unit permits switching of the engine fuel from the first fuel to the second fuel after a condition is met that includes completion of the air-fuel ratio learning related to the first fuel.

2. The fuel supply apparatus according to claim 1, wherein the first fuel is an engine starting fuel, which is used for starting the engine.

3. The fuel supply apparatus according to claim 1, wherein the first fuel is gasoline, and the second fuel is a compressed natural gas.

4. A method for controlling a fuel supply apparatus that is configured to switch an engine fuel injected into an internal combustion engine to one of a first fuel and a second fuel, comprising:
executing air-fuel ratio learning related to an injection amount of the engine fuel such that an actual air-fuel ratio detected by an air-fuel ratio sensor provided in the internal combustion engine agrees with a target air-fuel ratio; and
during an operation with the first fuel, permitting switching of the engine fuel from the first fuel to the second fuel after a condition is met that includes completion of the air-fuel ratio learning related to the first fuel.
